(19) United States
(12) Patent Application Publication
(10) Pub. No.: US 2011/0318099 A1
(43) Pub. Date: Dec. 29, 2011

(54) ANCHOR DEVICE FOR ANCHORING AN ELEMENT SUCH AS A FLUID COUPLING IN AN OPENING IN A WALL

(75) Inventor: Philippe Le Quere, Betton (FR)

(73) Assignee: PARKER HANNIFIN FRANCE SAS, Rennes (FR)

(21) Appl. No.: 13/179,675

(22) Filed: Jul. 11, 2011

(30) Foreign Application Priority Data
Jan. 14, 2009 (FR) 0900144
Dec. 23, 2009 (FR) PCT/FR2009/001479

(51) Int. Cl. F16B 17/00

(52) U.S. Cl. 403/376

(57) ABSTRACT

An anchor device for anchoring an element such as a coupling in an opening in a wall the device including a sleeve for receiving the element, the sleeve being externally provided with a shoulder for bearing against a first face of the wall, and with an anchor member facing the shoulder having a portion that is resiliently movable between a laterally projecting position and a retracted position. The anchor member is a frustoconical ring received in a groove in the outside of the sleeve, the ring having larger end facing the shoulder with a sloping surface which forms the resiliently movable portion and which bears in the laterally projecting position against a zone of intersection between a side surface of the opening and a second face of the wall.

### CROSS-REFERENCE TO RELATED APPLICATIONS

This application is a continuation of co-pending International Application No. PCT/FR2009/001479, filed Dec. 23, 2009, which designated the United States, and which claims priority to French Application No. 09 00144, filed Jan. 14, 2009, the disclosure of each of which is expressly incorporated herein by reference.

### BACKGROUND OF THE INVENTION

The present invention relates to an anchor device for anchoring an element in an opening in a wall. For example, the element may be a coupling for connecting together two members of a fluid circuit such as members for delivering or for receiving fluid, and, for example, pipes, a manifold, an actuator, a flow-rate regulator or a pressure regulator, etc. The invention also provides such a coupling.

Anchor devices are employed for anchoring an element in an opening in a wall having a first face and a second face that are opposite from each other. Such devices generally include a sleeve for receiving the element. The sleeve may be externally provided with a shoulder for bearing against the first face of the wall and with an anchor member for bearing against the second face of the wall.

For example, the anchor member may be constituted by a nut engaged over a threaded outside portion of the sleeve. Such mode of anchoring is relatively heavy and impractical, and requires some time. In addition, such screw-fastening presupposes that access is available to both sides of the wall, which is not always possible, e.g. when the wall defines a tank. In addition, if the wall and/or the device are subjected to vibration, there exists a risk of the nut working loose, thereby adversely affecting the strength of the fastening.

Consideration has been given to an anchor member having resilient arms, each of which has a free end that is resiliently movable between a laterally projecting position for bearing against the second face of the wall and a retracted position for enabling the sleeve to be inserted into the opening. It is then relatively complicated and costly to make the sleeve.

### SUMMARY OF THE INVENTION

It therefore is desired to provide a way making it possible to anchor an element in a wall in simple and inexpensive manna. To this end, the invention provides an anchor device for anchoring an element in an opening in a wall having a first face and a second face that are opposite from each other, the opening being defined by a side surface extending between the first face and the second face. The device includes a sleeve for receiving the element. The sleeve is externally provided with a shoulder for bearing against the first face of the wall, and with an anchor member that faces the shoulder and that has at least one portion that is resiliently movable between a laterally projecting position and a retracted position. The anchor member is a frustoconical ring received in a groove in the outside of the sleeve so as to have an end of larger section that faces the shoulder and that has a sloping surface, so as to bear, in the laterally projecting position, against a zone of intersection between the side surface of the opening and the second surface. Preferably, the anchor device of the invention is also provided with a seal for sealing the opening in the wall.

Thus, the attachment member is formed merely of a frustoconical washer received in a groove in the sleeve. The attachment member and the sleeve can then be manufactured independently from each other without giving rise to high manufacturing costs, the shape of the attachment member and the shape of the sleeve remaining relatively simple. The bearing against the zone of intersection between the side surface of the opening and the second surface makes it possible to increase the pull-out resistance of the anchoring by directing the force exerted against the ring by the zone of intersection towards a side of the groove. In addition, the ring makes it possible to take up clearance and to accommodate variations in the thickness of the wall. This bearing, associated with the resilience of the ring, also makes it possible to limit the assembly clearance between the sleeve and the wall.

Preferably, the sloping surface of the frustoconical ring is a face that is not perpendicular to the main faces of the ring (the main faces being to be understood as the inside and outside surfaces of the ring). According to a particular embodiment, the sloping surface is smooth and the ring is arranged to exert on the sleeve a force for attracting the shoulder towards the first face. The ring thus contributes to pressing the shoulder against the first face.

Preferably, the ring has an end of smaller section that has a face extending in a substantially radial plane when the ring is in its attachment position so as to bear against a side of the groove that is further from the shoulder. The face of the smaller section of the ring makes it possible to distribute the force transmitted by the ring to the adjacent side of the groove and thereby limits the zones of stress concentration.

Advantageously, the ring has an inside surface and has an end of smaller section in the vicinity of which the inside surface has a portion that is substantially cylindrical when the ring is in its attachment position. The cylindrical portion enables the ring to be centered properly on the sleeve.

Advantageously, a plane groove is provided in the shoulder and receives a seal that projects relative to the shoulder, the seal being arranged to be axially compressible. Axial compression of the seal takes place in accordance with the invention while the device is being put in place through the wall (in particular a partition wall). The sloping surface of the frustoconical ring that makes it possible to keep the seal axially deformed, and that thus guarantees that the wall is leaktight in the zone of its opening. It should be noted that, in order for the sloping surface of the frustoconical ring to apply its force correctly for attracting the shoulder of the sleeve, it is preferable for the ring to be concentric with the opening in the wall, and therefore to be concentric with the coupling, which is centered. As described in more detail below, it a guide surface of the ring makes it possible for this coaxial positioning to be achieved.

It is thus the way the frustoconical ring of the invention is arranged that makes it possible to guarantee that the opening in the wall is sealed in leak-tight manner. The seal can then be used for taking up the assembly clearance, allowed for assembling the sleeve to the wall, by exerting a force on the sleeve that tends to press the larger-section of the ring against the zone of intersection between the second face and the side surface of the opening.

The invention also provides a coupling including a tubular body that is axially subdivided into a connection segment for connecting to a first member of a fluid circuit, and a connection segment for connecting to a second member of the fluid circuit, and that is associated with a sleeve of an anchor device presenting any of the above characteristics.

In two alternative embodiments:

a. the body is mounted in the sleeve, the body is a force fit in the sleeve, and preferably the sleeve is provided with at least one piece in relief for retaining the body of the coupling in barb-like manner; and

b. the body is formed integrally as a single piece with the sleeve.

Other characteristics and advantages of the invention appear on reading the following description of particular non-limiting embodiments of the invention. The present invention, accordingly, comprises the construction, combination of elements, and/or arrangement of parts and steps which are exemplified in the detailed disclosure to follow.

### BRIEF DESCRIPTION OF THE DRAWINGS

Reference is made to the accompanying drawings, in which:

FIG. 1 is an axial section view of an anchor device of the invention;

FIG. 2 is a view analogous to FIG. 1, showing a coupling equipped with the anchor device;

FIG. 3 is an elevation view with an axial half-section view of a ring of the device;

FIG. 4 is a fragmentary view of the anchor device showing how the anchor device is adapted to accommodate a wall of a different thicknesses;

FIG. 5 is a fragmentary view of the anchor device showing how the anchor device is adapted to accommodate a wall of another different thickness;

FIG. 6 is a view analogous to FIG. 4 showing a first variant embodiment of the ring of the device;

FIG. 7 is a view analogous to FIG. 5 of the first variant embodiment of the ring of the device;

FIG. 8 is an elevation view of a second variant embodiment of a ring;

FIG. 9 is a view analogous to FIG. 2 showing a second embodiment of a coupling;

FIG. 10 is an elevation view with an axial half section view of a third embodiment of a coupling; and

FIGS. 11a to 11d show the succession of operations for anchoring (FIGS. 11a-11c) a fourth embodiment of a coupling of the invention, and removing (FIG. 11d) the coupling.

The drawings will be described further in connection with the following Detailed Description of the Invention.

### DETAILED DESCRIPTION OF THE INVENTION

The anchor device of the invention is described herein in application to fastening a coupling designated by overall reference 50 to a wall 100 that has a first face 101 and a second face 102 opposite from the first face. The wall 100 is provided with an opening 103 defined by a side surface extending between the faces 101 and 102.

With reference to FIG. 2, the coupling 50 includes a tubular body 51 axially subdivided into a connection segment 51.1 for connecting to a first member of a fluid circuit, and a connection se ent 51.2 for connecting to a second member of the fluid circuit. These connections are known and are not therefore described in detail herein. Such connections are arranged to connect the members to the coupling instantaneously or otherwise, and releasably or otherwise. The body 51 is provided externally with the anchor device.

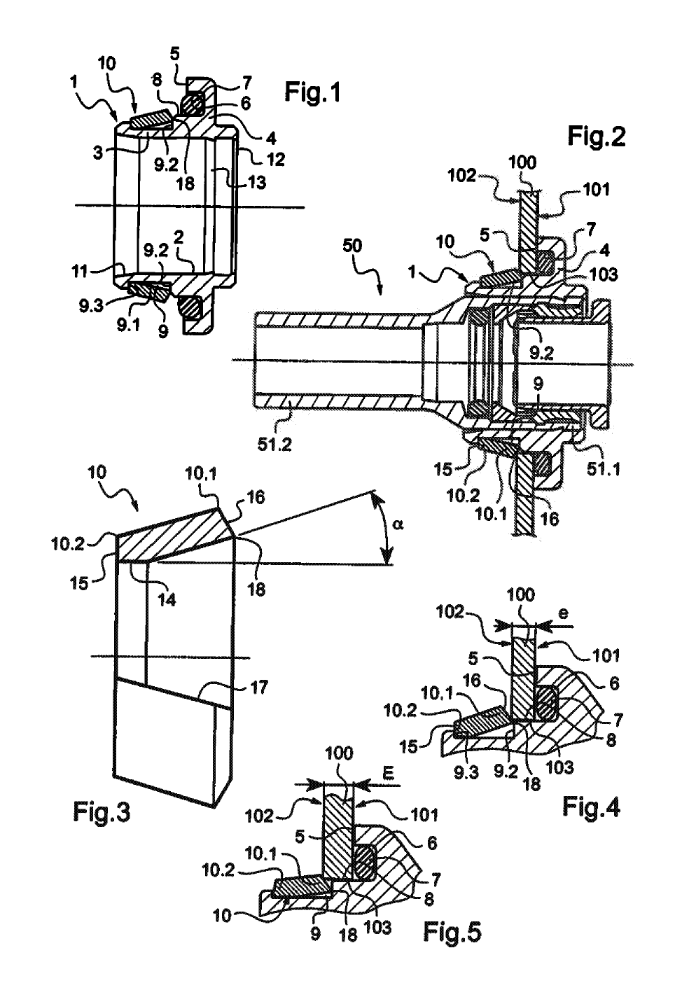

With reference to FIGS. 1 to 5, the anchor device includes a sleeve that is designated by overall reference 1, that is of tubular shape, that defines a channel 2, and that has a portion 3 that is insertable into the opening 103 and that extends projecting from an external collar 4 of the sleeve 1. Closer to the free end of the insertable portion 3, the channel 2 is provided with an inlet bevel 11 through which to insert the coupling 50 into the sleeve 1, and, close to the opposite end, the channel is provided with a rim 12 forming an abutment for preventing the coupling 1 from being pushed any further through the sleeve 1. A barb-like retaining annular piece in relief 13 extends into the channel 2 in the vicinity of the rim 12 so as to bite into the outside surface of the body of the coupling and so as to oppose withdrawal thereof.

The external collar 4 has an annular face forming a shoulder 5 closer to the insertable portion 3. A plane groove 6, concentric to the sleeve 1, is provided in the shoulder 5 for the purpose of receiving a seal 7 projecting from the shoulder 5.

The insertable portion 3 has an outside surface that, in the immediate vicinity of the collar 4, defines a bearing surface 8 of diameter slightly smaller than the diameter of the opening 103. A groove 9 is provided externally in the outside surface of the insertable portion 3 of the sleeve 1. The groove 9 has an end wall 9.1 flanked by a side 9.2 closer to the bearing surface 8 and by a side 9.3 closer to the free end of the insertable portion 3. The groove 9 receives a ring that is designated by overall reference 10.

The ring 10 is a frustoconical ring having a larger-diameter section 10.1 and a smaller-diameter section 10.2. In this example, the ring 10 is formed by a strip rolled up to form a truncated cone in such a manner as to have a substantially axial split 17 allowing it to be mounted resiliently in the groove and allowing it then to be elastically deformed between an anchoring state or rest state, shown in FIGS. 1 and 3, in which state the end of larger section 10.1 of the ring 10 extends such that it projects laterally relative to the groove 9 and relative to the bearing surface 8, and a deformed state in which the end of larger section 10.1 is retracted into the groove 9.

Closer to its end of smaller section 10.2, the ring 10 is provided with an inside surface portion 14 that is cylindrical so that it extends facing the end wall 9.1 of the groove 9, and so as to keep the washer coaxial with the sleeve 1. The end of smaller section 10.2 also has a face 15 arranged to extend radially when the ring 10 is in its anchoring state or rest state, and to bear against the side 9.3 of the groove 9.

The end of larger section 10.1 of the ring 10 has a frustoconical surface 16 having its angle at the apex situated closer to the shoulder 5, so that when the ring 10 is in its anchoring state, the surface 16 can bear against a zone of intersection between the side surface of the opening 103 and the face 102 of the wall 100. The extent to which the ring 10 flares frustoconically is chosen to be relatively small so as limit the forces to be exerted on installing the anchor device in the opening 103, and also so as to limit the structural deformation of the ring 10 in a manner such as to remain within the elastic limit of the material of which it is made. It should be noted that in the projecting position, the and of larger section 10.1 has an edge 18 (forming the inner circumference of the surface 16) that extends facing the side 9.2 of the groove 9 so as to prevent the ring 10 from overlapping the bearing surface 8 while the anchor device is inserted into the opening, and from thereby being prevented from deforming into the retracted state.

In FIG. 2, the coupling 50 is anchored in the opening 103. While the coupling 50 as provided with the anchor device is being inserted into the opening 103, the ring 10 is in its deformed state, so that the end of larger section 10.1 is in its retracted position. As the ring 10 comes out of the opening 103 on the other side, the resilience of the ring returns it to its anchoring state until the surface 16 of the ring 10 comes to bear against the zone of intersection between the side surface of the opening 103 and the face 102. It can be understood that the seal 7 is flattened between the end wall of the groove 6 and the face 101 of the wall 100, and tends resiliently to urge the collar 4 away from the wall 100, thereby reinforcing the contact between the surface 16 and the zone of intersection between the side surface of the opening 103 and the face 102. The seal 7 seals the connection between the anchor device and the wall 100. The bearing surface 8 ensures that the anchor device is centered in the opening 103. The face 15 that extends substantially radially when the ring 10 is in its anchoring state, enables the ring 10 to bear firmly against the side 9.3 of the groove 9.

In FIGS. 4 and 5, it can be seen that the anchor device of the invention adapts automatically to different thicknesses, referenced at “e” in FIG. 4 and at “E” in FIG. 5, of wall 100. Such adaptation is the result of the frustoconical nature of the face 16 and of the variation in the extent to which the ring 10 returns to its attachment state or rest state.

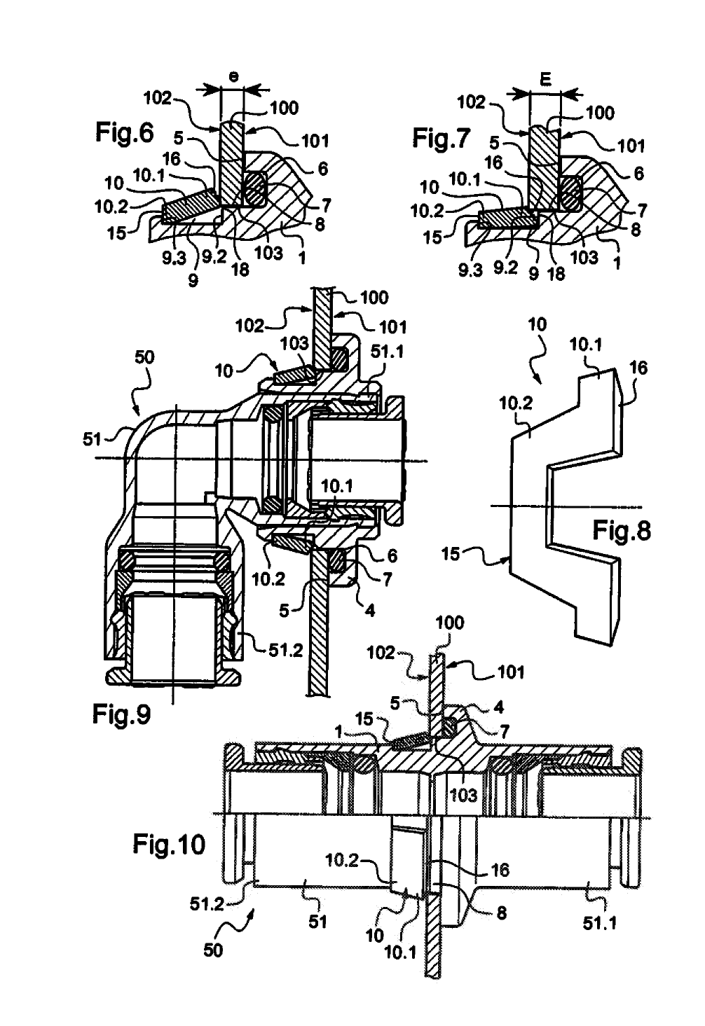

In a variant, as shown in FIGS. 6 and 7, the surface 16 may have a stair-shaped profile.

In a variant, in FIG. 8, the ring 10 is not a split ring, but it is of crenellated shape in part, facilitating resiliently mounting it in the grove, and then facilitating elastic deformation of the ring 10 from its anchoring state to its retracted state.

In the second embodiment shown in FIG. 9, it can be seen that the body 51 of the coupling 50 is L-shaped and has an identical connection at both of its ends 51.1 and 51.2.

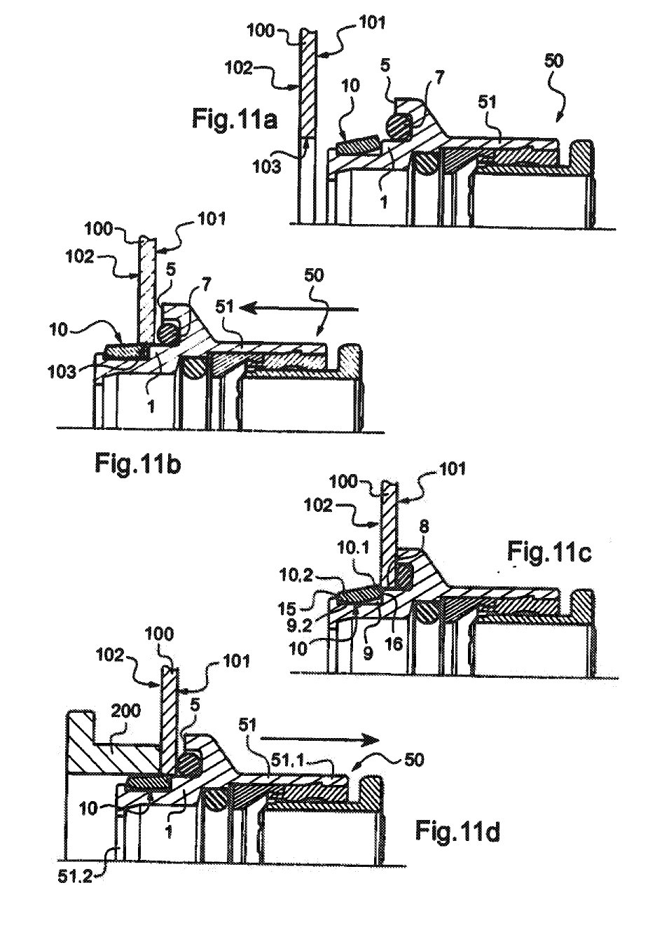

In the third and fourth embodiment, shown respectively in FIG. 10 and in FIG. 11, the body 51 of the coupling 50 is formed in one piece with the sleeve 1 of the anchor device. The third embodiment in FIG. 10 shows a coupling or union making it possible to couple two pipes together. The fourth embodiment in FIG. 11 shows a coupling 50 making it possible to couple a pipe directly to a pressurized enclosure that is defined by the wall 100.

FIG. 11a shows the coupling 50 before it is inserted into the opening 103. FIG. 11b shows the coupling 50 while it is being inserted, the ring 10 is in its deformed state so that the end of larger section 10.1 is in its retracted position. FIG. 11c shows the coupling 50 once the ring 10 has come through the opening 103 and out the other side and returns to its rest state under the effect of its resilience. The end of larger section 10.1, projecting laterally relative to the bearing surface 8, bears via its surface 16 against the intersection between the side surface of the opening 103 and the face 102. The seal 7 is flattened between the face 101 and the end wall of the groove 6.

FIG. 11d shows the coupling 50 being withdrawn via a tubular tool 200 threaded over the segment 51.1 of the body 51, the end of smaller section 10.2 and the ring 10 until it overlaps the end of larger section 10.1 and brings the end of larger section into its retracted position. The body 51 may then be withdrawn by causing the ring 10 to pass into the opening 103.

The invention is not limited to the embodiment described, and variant embodiments may be provided without going beyond the ambit of the invention as defined by the claims. As it is anticipated that certain changes may be made in the present invention without departing from the precepts herein involved, it is intended that all matter contained in the foregoing description shall be interpreted in as illustrative rather than in a limiting sense. All references including any priority documents cited herein are expressly incorporated by reference.

What is claimed is:

1. An anchor device for anchoring an element in an opening in a wall having a first face and a second face opposite the first face, the opening having a side surface extending between the first face and the second face of the wall and intersecting with the wall second face along a zone of intersection, the device comprising:
a generally tubular sleeve for receiving the element extending between a first sleeve end insertable from the wall first face through the opening and a second sleeve end, the sleeve having an external shoulder disposed intermediate the first sleeve end and the second sleeve end, and the sleeve having an external circumferential first groove disposed intermediate the shoulder and the second sleeve end; and
an anchoring ring received coaxially in the sleeve first groove, the ring having a larger diameter section facing the shoulder resiliently movable between a laterally projecting position and a retracted position, the larger diameter section having a sloping surface,
wherein with the first sleeve end being inserted from the wall first face through the opening, the sleeve sloping surface in the laterally projecting position of the sleeve larger end bears against the zone of intersection delimiting the removal of the first sleeve end from the opening.

2. The device of claim 1 wherein the sloping surface as bearing against the zone of intersection urges the sleeve shoulder towards the wall first face.

3. The device of claim 1 wherein:
the sleeve first groove has an side nearer the second sleeve end; and
the ring has a smaller diameter section opposite the larger diameter section, the ring smaller diameter section having an end face bearing against the side of the sleeve first groove as the ring sloping surface bears against the zone of intersection.

4. The device of claim 1 wherein:
the sleeve first groove has a generally cylindrical side wall; and
the ring has a smaller diameter section opposite the larger diameter section, the ring smaller diameter section having an inside surface facing the first groove side wall, the inside surface being generally cylindrical in the laterally projecting position of the sleeve larger end.

5. The device of claim 1 wherein:
the sleeve shoulder has an annular second groove provided therein; and
the device further comprises an annular seal received with the shoulder second groove, the seal being compressible between the shoulder and the wall first surface as the ring sloping surface bears against the zone of intersection.

6. The device of claim 1 the ring sloping surface has a stair-shaped profile.

7. The device of claim 1 wherein the sleeve defines a channel, the channel being configured to receive a generally tubular coupling coaxially therein.

8. The device of claim 7 wherein the channel has a radially inwardly extending barb for retaining the coupling therein.

9. The device of claim 1 wherein
the sleeve first groove has an side nearer the first sleeve end; and
the ring larger section has an edge facing the groove side when the ring larger section is in the projecting position.

10. An assembly comprising:
a generally tubular coupling having a first coupling end configured as a first connection segment for connecting to a first member of a fluid circuit, and a second coupling end configured as a second connection segment for connecting to a second member of the fluid circuit; and
an anchor device for anchoring the coupling in an opening in a wall having a first face and a second face opposite the first face, the opening having a side surface extending between the first face and the second face of the wall and intersecting with the wall second face along a zone of intersection, the device comprising:
a generally tubular sleeve defining a channel for receiving the coupling coaxially therein, the sleeve extending between a first sleeve end insertable from the wall first face through the opening and a second sleeve end, the sleeve having an external shoulder disposed intermediate the first sleeve end and the second sleeve end, and the sleeve having an external circumferential first groove disposed intermediate the shoulder and the second sleeve end; and
an anchoring ring received coaxially in the sleeve first groove, the ring having a larger diameter section facing the shoulder resiliently movable between a laterally projecting position and a retracted position, the larger diameter section having a sloping surface,
wherein with the first sleeve end being inserted from the wall first face through the opening, the sleeve sloping surface in the laterally projecting position of the sleeve larger end bears against the zone of intersection delimiting the removal of the first sleeve end from the opening.

11. The assembly of claim 10 wherein the sloping surface as bearing against the zone of intersection urges the sleeve shoulder towards the wall first face.

12. The assembly of claim 10 wherein:
the sleeve first groove has an side nearer the second sleeve end; and
the ring has a smaller diameter section opposite the larger diameter section, the ring smaller diameter section having an end face bearing against the side of the sleeve first groove as the ring sloping surface bears against the zone of intersection.

13. The assembly of claim 10 wherein:
the sleeve first groove has a generally cylindrical side wall; and
the ring has a smaller diameter section opposite the larger diameter section, the ring smaller diameter section having an inside surface facing the first groove side wall, the inside surface being generally cylindrical in the laterally projecting position of the sleeve larger end.

14. The assembly of claim 10 wherein:
the sleeve shoulder has an annular second groove provided therein; and
the device further comprises an annular seal received with the shoulder second groove, the seal being compressible between the shoulder and the wall first surface as the ring sloping surface bears against the zone of intersection.

15. The assembly of claim 10 the ring sloping surface has a stair-shaped profile.

16. The assembly of claim 10 wherein the coupling is received coaxially in the channel.

17. The assembly of claim 16 wherein the channel has a radially inwardly extending barb, the coupling being interferingly retained in the channel by the barb.

18. The assembly of claim 16 wherein the coupling is press-fit in the channel.

19. The assembly of claim 10 wherein
the sleeve first groove has an side nearer the first sleeve end; and
the ring larger section has an edge facing the groove side when the ring larger section is in the projecting position.

20. An anchor device for anchoring in an opening in a wall having a first face and a second face opposite the first face, the opening having a side surface extending between the first face and the second face of the wall and intersecting with the wall second face along a zone of intersection, the device comprising:
a generally tubular sleeve for receiving the element extending between a first sleeve end configured as a first connection segment for connecting to a first member of a fluid circuit and insertable from the wall first face through the opening, and a second sleeve end configured as a second connection segment for connecting to a second member of a fluid circuit, the sleeve having an external shoulder disposed intermediate the first sleeve end and the second sleeve end, and the sleeve having an external circumferential first groove disposed intermediate the shoulder and the second sleeve end; and
an anchoring ring received coaxially in the sleeve first groove, the ring having a larger diameter section facing the shoulder resiliently movable between a laterally projecting position and a retracted position, the larger diameter section having a sloping surface,
wherein with the first sleeve end being inserted from the wall first face through the opening, the sleeve sloping surface in the laterally projecting position of the sleeve larger end bears against the zone of intersection delimiting the removal of the first sleeve end from the opening.

21. The device of claim 20 wherein the sloping surface as bearing against the zone of intersection urges the sleeve shoulder towards the wall first face.

22. The device of claim 20 wherein:
the sleeve first groove has an side nearer the second sleeve end; and
the ring has a smaller diameter section opposite the larger diameter section, the ring smaller diameter section having an end face bearing against the side of the sleeve first groove as the ring sloping surface bears against the zone of intersection.

23. The device of claim 20 wherein:
the sleeve first groove has a generally cylindrical side wall; and
the ring has a smaller diameter section opposite the larger diameter section, the ring smaller diameter section having an inside surface facing the first groove side wall, the inside surface being generally cylindrical in the laterally projecting position of the sleeve larger end.

24. The device of claim 20 wherein:
the sleeve shoulder has an annular second groove provided therein; and
the device further comprises an annular seal received with the shoulder second groove, the seal being compressible between the shoulder and the wall first surface as the ring sloping surface bears against the zone of intersection.

25. The device of claim 20 the ring sloping surface has a stair-shaped profile.

26. The device of claim 20 wherein
the sleeve first groove has an side nearer the first sleeve end; and
the ring larger section has an edge facing the groove side when the ring larger section is in the projecting position.
